(19) United States
(12) Patent Application Publication
(10) Pub. No.: US 2004/0258784 A1
(43) Pub. Date: Dec. 23, 2004

(54) Device for granulating a thermoplastic, which is extruded from nozzles

(76) Inventor: Reinhardt-Karsten Muerb, Aschaffenburg (DE)

Correspondence Address: BANNER & WITCOFF, 1001 G STREET N W, SUITE 1100, WASHINGTON, DC, 20001, US

(21) Appl. No.: 10/485,364

(22) PCT Filed: Jul. 23, 2002
(86) PCT No.: PCT/EP02/08208

(30) Foreign Application Priority Data
Aug. 1, 2001 (DE) 10 137 525.5

(51) Int. Cl. B29B 9/06

(52) U.S. Cl. 425/67; 425/313

(57) ABSTRACT

The invention relates to a device for granulating thermoplastic materials issuing from orifices, said orifices being provided in a substantially circular arrangement in an orifice plate and being swept by blades rotating about a blade carrier shaft, said blades being held by a bell-shaped blade carrier in an oblique position with respect to the radial direction, the blade carrier shaft extending through the centre of the circular arrangement, a cooling medium being supplied to the orifice plate and to the blades for cooling the granulated plastic materials, wherein between the blade carrier and the orifice plate there is an annular intermediate space which is flowed through from inside to outside by the cooling medium. The hollow space (24) of the bell-shaped blade carrier is in communication with the intermediate space and the cooling medium is supplied to the intermediate space from the hollow space of the blade carrier.

The invention relates to a device for granulating thermoplastic materials issuing from orifices, said orifices being provided in a substantially circular arrangement in an orifice plate and being swept by blades rotating about a blade carrier shaft, said blades being held by a bell-shaped blade carrier in an oblique position with respect to the radial direction, the blade carrier shaft extending through the centre of the circular arrangement, a cooling medium being supplied to the orifice plate and to the blades for cooling the granulated plastic materials, wherein between the blade carrier and the orifice plate there is an annular intermediate space which is flowed through from inside to outside by the cooling medium. This is, therefore, a device for so-called hot-melt granulation in which the plastic extrudate issuing from the orifices is cut directly at the orifices, i.e. while still in the molten state.

Such a device is presented in U.S. Pat. No. 3,317,957. The special feature of this known device consists in the fact that the cooling medium is supplied from the same side as the molten thermoplastic material, said cooling medium being supplied via channels which extend parallel to the blade carrier shaft and which lie radially within the circular arrangement of the orifices. The blade carrier is driven likewise from the same side from which the plastic melt is supplied, with the result that the entire arrangement with the supplies for the plastic melt and the cooling medium is penetrated by the drive shaft, which becomes the blade carrier shaft. This results in a complex construction, particularly because of the required sealing means, wherein, owing to the limited space available for the supply channels for the cooling medium, said supply channels are formed with relatively small cross section, the consequence of this being that it is necessary to apply considerable pressures in order to conduct the necessary quantity of cooling medium.

The object of the invention is to simplify and therefore improve the design of the initially described device, particularly with regard to the flow conditions for the cooling medium, and in this manner to guarantee a reliable flow of cooling medium around the just-cut granules as well as rapid conveying-away of the granules, so that there can be no agglomeration among the granules.

The object of the invention is achieved in that the hollow space of the bell-shaped blade carrier is in communication with the intermediate space between blade carrier and orifice plate and the cooling medium is supplied to the intermediate space from the hollow space of the blade carrier.

With this design, the cooling medium is supplied via a region which is remote from the region in which the plastic melt is supplied, with the consequence that it is readily possible to prevent heat losses or undesired heating of the cooling medium. In the known arrangement, it is considerably more difficult to rule out such heat transfers because, as explained above, the cooling medium is supplied axially within the region in which the plastic melt is supplied. The arrangement according to the invention makes it possible for the plastic melt to be supplied from one side of the device and for the cooling medium to be supplied from the opposite side of the device, with the consequence that the said two regions only meet where the granulation takes place, namely in the region of the blade carrier, where, owing to the intermediate space between blade carrier and orifice plate, there is a region which, because it is supplied from the interior of the bell-shaped blade holder, is in all places subject to a uniform throughflow with a correspondingly greater volume of cooling medium, this guaranteeing a correspondingly uniform cooling and reliable conveying-away of the granulate.

The intermediate space between blade carrier and orifice plate can be advantageously designed in that the intermediate space is closed off at the sides by an annular plate—attached to the blade carrier and penetrated by the blades—and by the oppositely disposed orifice plate, the blades projecting, in the form of individual rigid strips, into the intermediate space from the annular plate up to contact with the orifice plate and being guided and held in the annular plate in penetrations directed obliquely towards the orifice plate.

This design results in a region—defined by the annular plate and the orifice plate and closed off at the sides—which provides easily controllable conditions for the throughflow of the cooling medium. The arrangement of the annular plate makes it possible to provide a secure mount for the blades in the form of individual rigid strips owing to the fact that the annular plate is provided with penetrations which are directed obliquely towards the orifice plate and in which the blade strips are inserted and located in position.

In the intermediate space defined by the annular plate and the orifice plate there is an outwardly directed flow of the cooling medium which, in consideration of the rotation of the blade carrier towards the outside, increasingly approaches the tangential. Advantageously, in this case the oblique position of the blades projecting into the intermediate space is so chosen that, as the annular plate rotates, said blades oppose a low flow resistance to the resulting flow. As a result of this choice of oblique position of the blades, the cooling medium flows past virtually unhindered as the blade carrier rotates. An oppositely directed oblique position would lead to a pumping effect of the blade carrier with the blades, this, however, being undesired in the herein underlying device because, firstly, this would result in unfavourable vortexes for the conveying-away of the granulate and, secondly, the pumping effect would lead to a corresponding expenditure of energy on the part of the drive motor, something which, in addition to the energy required for granulation, would signify an unnecessary loss of energy.

The fact that the blades, consisting of strips, are supported in the annular plate makes it possible in advantageous manner for the blades to be individually adjustable on the annular plate, said annular plate together with the blade carrier being disposed at a fixed distance from the orifice plate, wherein, in order to compensate for wear, said blades can during operation be individually pressed against the orifice plate by pressure means. In this case, the blades are slidingly held in the penetrations in the annular plate, with the result that, in order to compensate for wear, the blades during operation automatically undergo slight adjustment in the direction of the orifice plate. The pressure means employed may be flexible springs, especially helical springs, or also hydraulically or pneumatically applied pressure.

In order further to reduce any remaining resistance of the blades with respect to the cooling medium as the blade carrier rotates, the blades are made of such a length that the radial extent of the blades exceeds the cross section of the orifices only slightly but to such a degree that the cut executed by the blades chops the plastic material issuing from the orifices into isolated plastic granules. This minimizes the length of the blades, as a result of which, as the blade carrier rotates, the blades exert only a small resistance with regard to the through-flowing cooling medium.

It may also be pointed out that the cooling medium used may primarily be water or, alternatively, oil or a gaseous medium, such as nitrogen. The choice of cooling medium will possibly depend on the chemical characteristics of the plastic material being granulated.

Illustrative embodiments of the invention are presented in the drawings, in which:

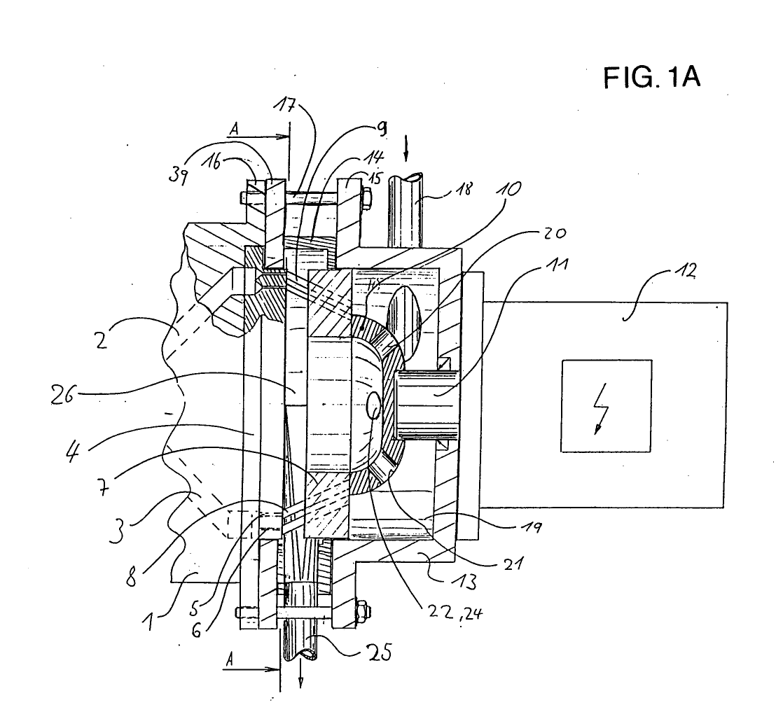

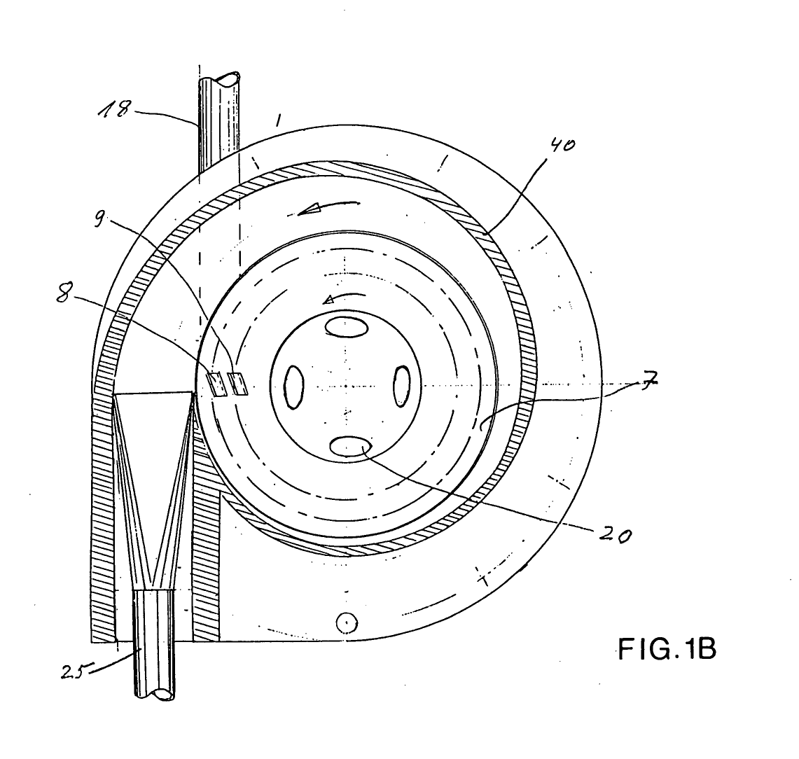

FIG. 1A shows the overall device in section;

FIG. 1B shows a section on the line A-A from FIG. 1;

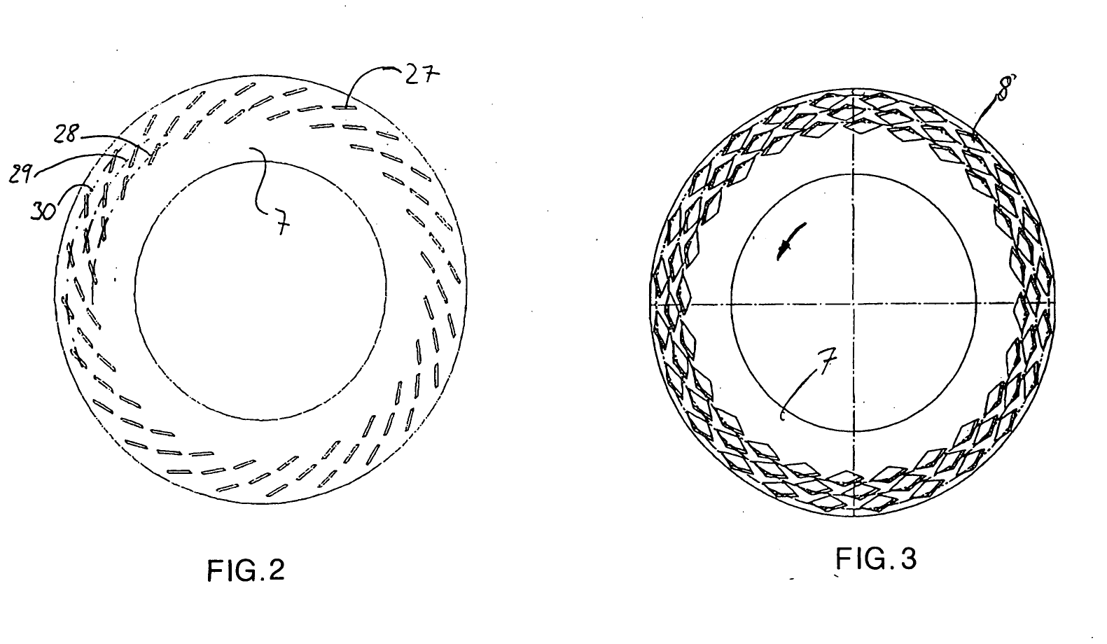

FIG. 2 shows a top plan view of the annular plate penetrated by slots for holding the strip-like blades for three circular arrangements of blades;

FIG. 3 shows the same annular plate with blades inserted in the penetrations;

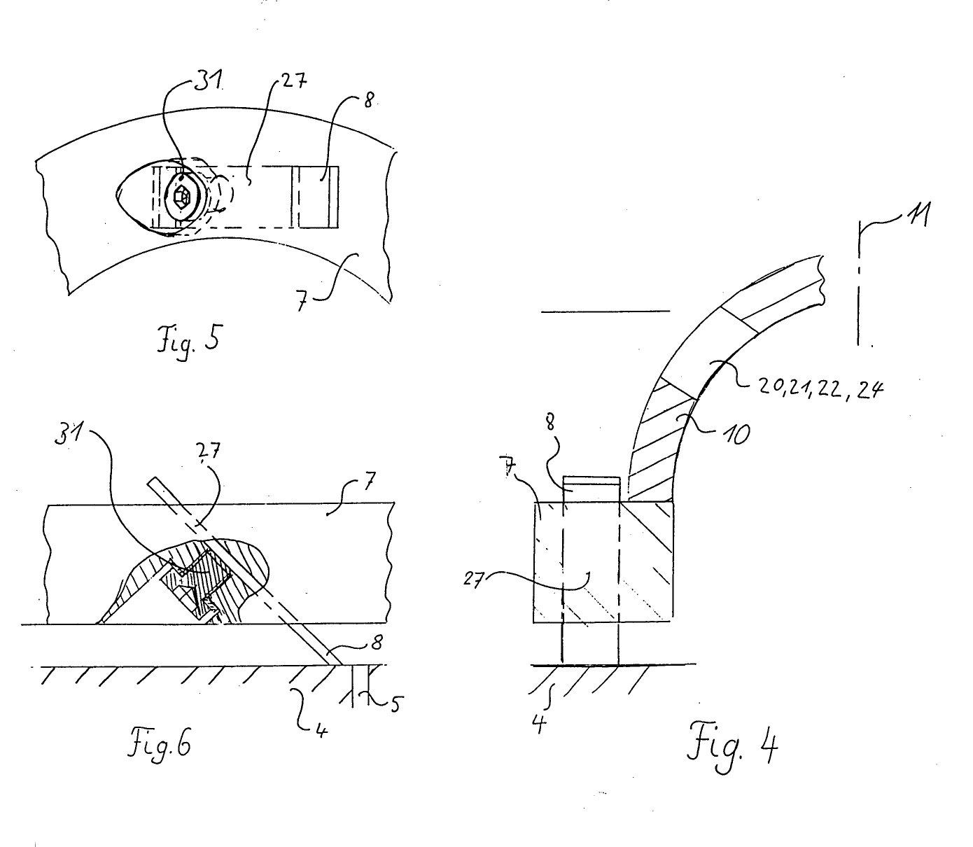

FIG. 4 shows a schematic representation of an annular plate with a blade as its sweeps the orifice plate;

FIG. 5 shows the arrangement according to FIG. 4 in a top plan view;

FIG. 6 shows the attachment of the blade in the penetration in the annular plate;

FIG. 7 shows a detail of the annular plate with a spring-loaded blade;

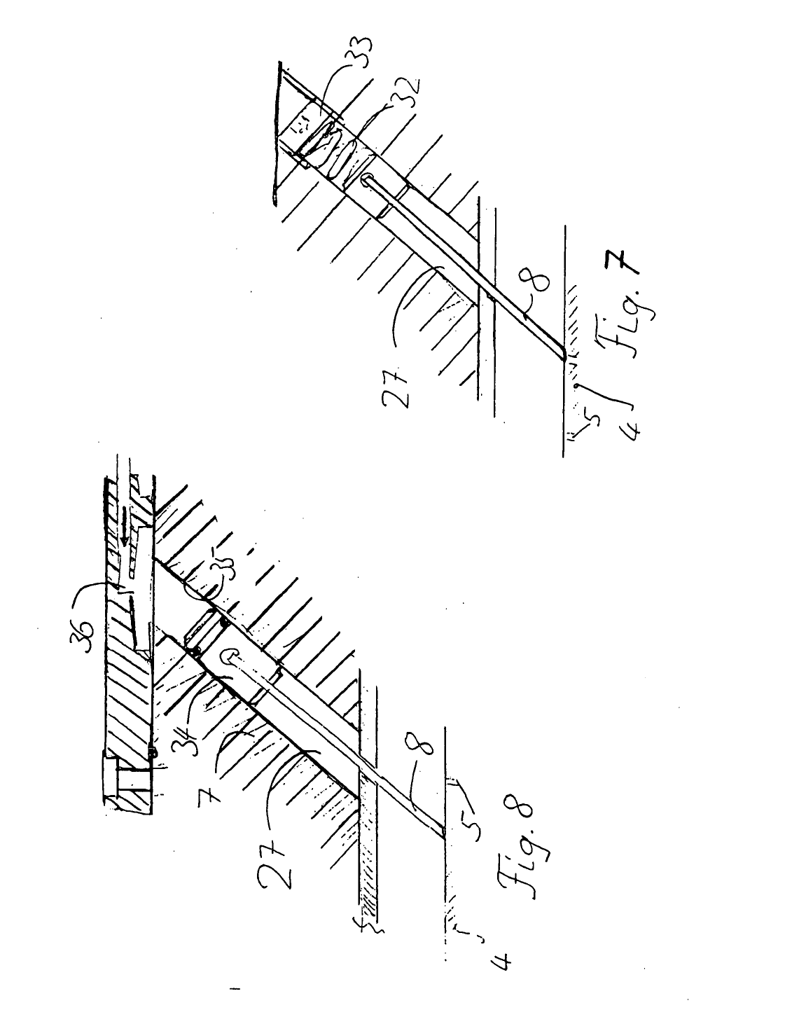

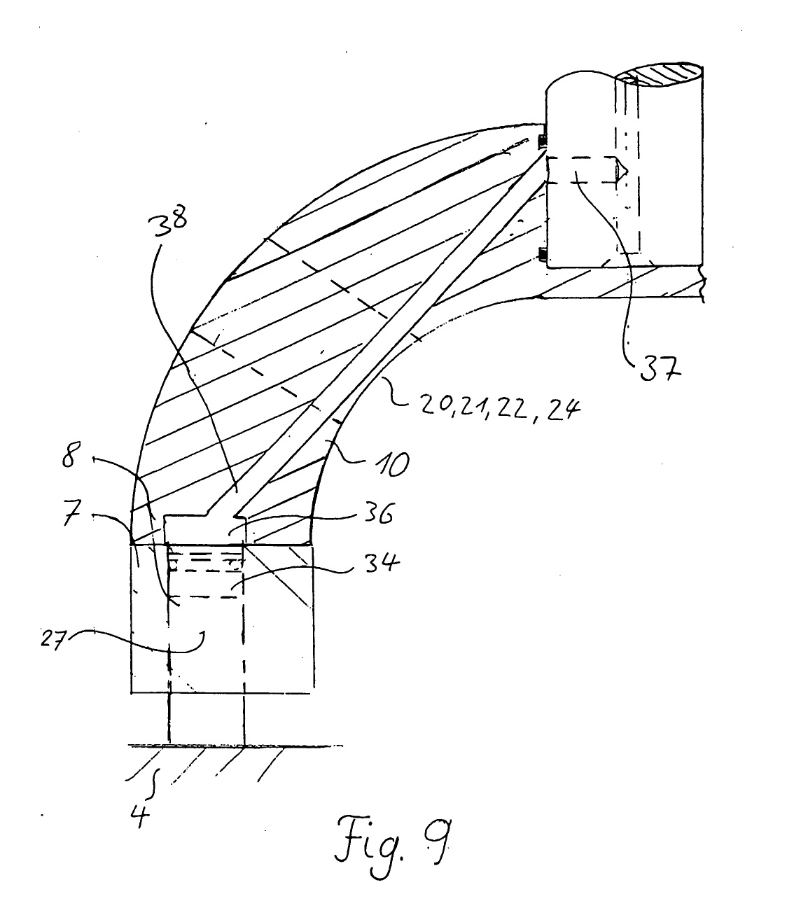

FIG. 8 shows a variant of the arrangement according to FIG. 7 in which the blade is pressed by a hydraulically actuated piston;

FIG. 9 shows the supply of a hydraulic fluid through the blade carrier shaft as far as the annular plate;

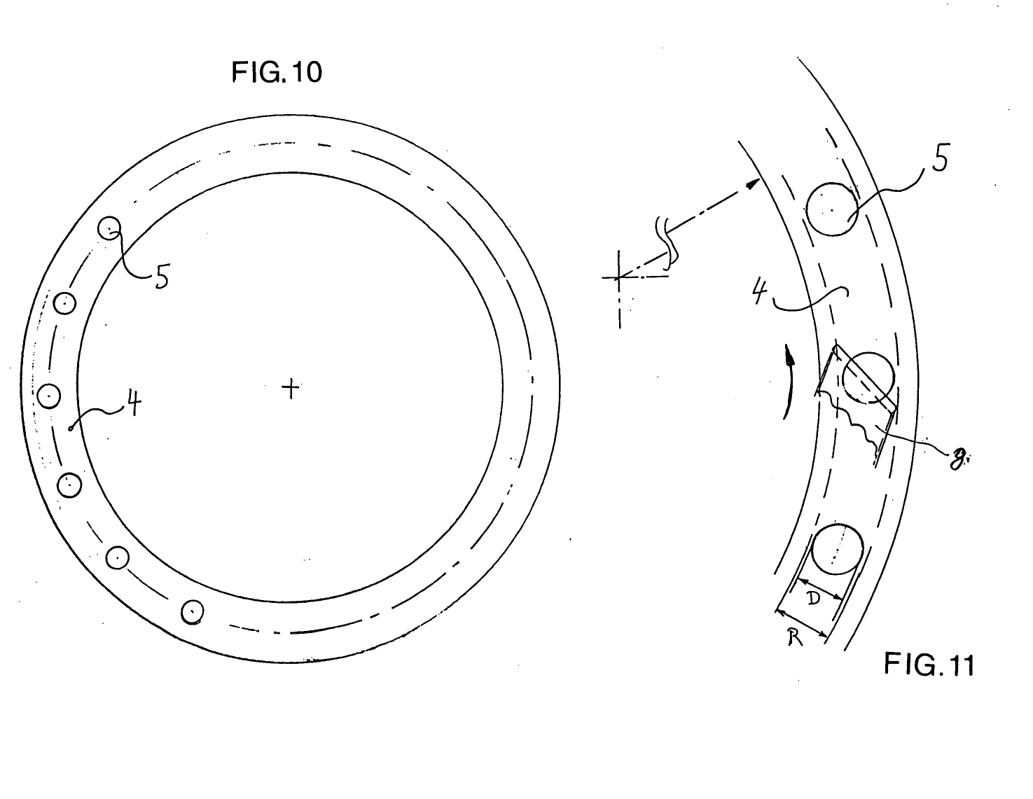

FIG. 10 shows a top plan view of the orifice plate with a single annular arrangement of orifices;

FIG. 11 shows an enlarged representation of some orifices according to FIG. 10 showing a blade which just exceeds the diameter of the orifices in the radial direction.

FIG. 1A shows a section through the device according to the invention, wherein those components not belonging to the invention, namely an extruder for supplying a molten plastic material, have been omitted. The device contains the melt distributor 1, which is used in known manner and comprises a plurality of melt channels, here the two channels 2 and 3. Flanged onto the melt distributor 1 by means of attachment means (not shown here) is the orifice plate 4 into which the melt channels 2 and 3 join, becoming the orifices 5 and 6. During operation, the thermoplastic material to be granulated issues in molten form from the orifices 5 and 6. The orifice plate 4 comprises further orifices, the circular arrangement of which is apparent from FIG. 10. Disposed opposite the orifice plate 4 is the annular plate 7 from which the blades 8 and 9 (and further blades not shown) project and in known manner sweep the surface of the orifice plate 4 facing the annular plate 7, chopping the thermoplastic extrudate issuing from the orifices 5 and 6. With regard to the arrangement and support of the blades 8 and 9 in the annular plate 7, reference is made to the explanatory remarks in respect of FIGS. 4 to 6. The annular plate 7 is attached to the bell-shaped blade carrier 10 which is situated at the end of the blade carrier shaft 11, said blade carrier shaft 11 joining into the drive motor 12 (shown only in outline). Through the intermediary of the blade carrier shaft 11, the drive motor 12 sets the blade carrier 10 and thus the annular plate 7 with the blades 8 and 9 in rotation, the supplied thermoplastic extrudate being granulated, as described above.

The internal parts of the said device are enclosed by the housing 13, which continues into the cover 14 extending over the region of the orifices 5 and 6 and of the blades 8 and 9. The two associated regions of plastic supply and granulation are held together by the flange-like shoulders 15 of the housing 13 and 16 of the melt distributor 1, this being accomplished by means of screws 17 which, when tightened, provide firm enclosing of the cover 14, whereby the entirety of the device, through the housing consisting of the parts 13 and 14, extends into the region of the melt distributor 1. As shown in FIG. 2, which will be discussed in greater detail below, the device according to FIG. 1 is substantially rotationally symmetrical; that is, the housing 13 with the cover 14 substantially has a circular surface on the outside. The mounting 39 provides the orifice plate 4 with the requisite centering.

The cover 14 belonging to the housing 13 is here formed of plexiglass, which, because of its transparency, makes it possible to observe what is happening in the region in which granulation takes place.

For the cooling of the granulate cut by the blades 8 and 9, the housing 13 and the region in which granulation takes place are supplied with a cooling medium, which, in this case, is cooling water, the cooling water being supplied through the coolant inlet 18. The coolant inlet 18 joins virtually tangentially into the interior 19 of the housing 13, this resulting in the housing 13 in a rotational flow, the rotational velocity of which can be adjusted by the volume of water supplied. The cooling water passes from the interior 19 via the flow openings 20, 21 and 22 into the hollow space 24 of the bell-shaped blade carrier 10. The blade carrier 10 rotates at the rotational velocity imparted to it by the drive motor 12. In order to supply the cooling water via the flow openings 20, 21 and 22 to the hollow space 24 in the blade carrier 10 in such a manner that the cooling water rotating in the interior 19 is able to flow out in largely turbulence-free manner into the flow opening 20, 21 and 22, the rate of supply of the cooling water and thus the rotational velocity of the cooling water in the interior 19 is regulated in such a manner that the cooling water in the interior 19 in the region of the flow openings 20, 21 and 22 circulates at the same rotational velocity as the flow openings 20, 21 and 22 rotate. This avoids losses of energy at this point as a result of different rotational velocities. This manner of adaptation of the rotational velocities is made possible by the tangential supply of the cooling water via the coolant inlet 18.

As can be seen, the hollow space 24 of the blade carrier 10 is in direct communication with the blades 8 and 9 as well as with the region of the orifice plate 4, because the bell-shaped blade carrier 10 is open towards the orifice plate 4, with the result that the cooling water entering the hollow space 24 of the blade carrier 10 is able to flow out past the blades 8 and 9 and over the surface of the orifice plate 4 to the outside. Such outflow is facilitated by the likewise tangentially disposed coolant outlet 25, which leads out of the intermediate space 26 between the orifice plate 4 and the annular plate 7. In the said intermediate space, the cooling water circulates owing to the rotation of the blade carrier 10 and of the blades 8 and 9, this circulation being in a direction which transitions directly into the tangential direction according to the coolant outlet 25. This, therefore, creates for the entire throughflow of the cooling water a direction and a transition from region to region which opposes the least possible resistance to the coolant throughflow and consequently has a correspondingly energy-reducing effect with regard to the drive motor 12.

FIG. 1B shows a section on the line A-A from FIG. 1A. This section, therefore, extends along the side of the orifice plate 4 facing the blades. This results in FIG. 1B in a top plan view of the annular plate 7 with the blades 8 and 9. The annular plate 7 is held by the blade carrier 10, in which the flow openings 20, 21 and 22 are provided (the fourth flow opening is not visible in FIG. 1). FIG. 1B additionally shows the cover 14, which extends from the point of the coolant outlet 25 in the form of a spiral around the annular plate 7, the space between the annular plate 7 containing the blades 8 and 9 and the outer wall of the cover 14 steadily becoming smaller and, conversely, steadily becoming wider in the flow direction (see arrow), with the result that, in this region, with increasing diameter of the said space, the flow velocity of the cooling water remains virtually constant, this being important for the turbulence-free flowing of the cooling water, which consequently conveys away the granulate after cutting with corresponding uniformity via the coolant outlet.

FIG. 2 shows the annular plate 7, attached to the blade carrier, alone without blades; more specifically, it shows a top plan view of the side on which the blades emerge. Thus, FIG. 2 shows the openings of the individual penetrations 27 into which the individual blades are inserted, as will be more fully explained below. FIG. 2 shows an annular plate with three circular arrangements 28, 29, 30.

FIG. 3 shows the same annular plate 7; this time, however, a blade 8 is inserted into each of the penetrations 27. As can be seen, said blades 8 project from the penetrations 27 obliquely with respect to the surface of the annular plate 7 and at an angle with respect to the direction of rotation. The blades 8 are obliquely positioned with regard to the direction of rotation, said oblique position being so selected that, owing to the oblique position, as the annular plate rotates there is only a low flow resistance with respect to the resulting flow of the cooling water.

Namely, the cooling water flows from inside to outside (see explanation with regard to FIG. 1A), the flow of the cooling water not extending directly radially outwards, but in the form of a spiral. The oblique position of each of the blades 8 is adapted to the respective angle of said spiral, with the result that the blades 8 oppose only a low flow resistance to the cooling water as it passes. The direction of rotation of the annular plate 7 is indicated by the arrow.

FIG. 4 is a schematic representation of the arrangement of a blade 8 with regard to the orifice plate 4 with the orifice 5. The blade 8 is inserted in a penetration 27 in the annular plate 7 and is attached therein, as will be explained hereinbelow. The orifice plate becomes the bell-shaped blade carrier 10, which is attached to the blade carrier shaft 11 indicated by the dash-dotted line.

FIG. 5 shows a top plan view of the region of the annular plate 7 shown with the blade 8 in FIG. 4, the blade 8 projecting from the annular plate 7. The blade 8 is inserted in the penetration 27 indicated by the dash-dotted lines. The blade 8 is attached to the annular plate 7 by the screw 31.

FIG. 6 shows the representation from FIG. 5 in a side view, this making it apparent how the blade is inserted into the blade carrier 7, i.e. into the penetration 27 provided for this purpose. The screw 31 then clamps the blade 8 in the penetration.

Similarly to FIG. 6, FIG. 7 shows a portion of the annular plate 7 with the penetration 27 into which the blade 8 has been inserted. Here, the blade 8 terminates in the central region of the annular plate 7, where the rear side of the blade 8 contacts the helical spring 32, said helical spring 32 being supported against an abutment 33. The helical spring 32 presses against the blades 8, said blades 8 being displaceably and therefore adjustably held in the annular plate 7 and consequently being in constant contact with the orifice plate 4 with a corresponding pressure. As the blade 8 wears and thereby becomes shorter, the helical spring 32 automatically presses the blade further in the direction of the orifice plate 4, this fully compensating for the wear which has taken place.

FIG. 8 shows a variant of the arrangement from FIG. 7 in which the rear side of the blade 8 is held in a piston 34 which is guided in a corresponding bore 35. The bore 35 is, as it were, a continuation of the penetration 27 towards the rear side of the orifice plate 4. The piston 34 is subjected to a pressure exerted either by a fluid or by a gas, said pressure being supplied through a special channel 36 of the bore 35. In this case, therefore, the wear on the blade 8 is compensated in the same manner as described above in connection with FIG. 7.

FIG. 9 is a schematic representation of the supply of a pressure medium of the kind required in the arrangement shown in FIG. 8. In this case, the pressure medium passes via the blade carrier shaft 10 into a central distributor 37, from where, via a bore 38, the pressure medium passes via the blade carrier 10 into the annular plate 7.

FIG. 10 shows the orifice plate 4, said orifice plate 4 in this case being provided with only one circular arrangement of orifices 4, 5. The orifices 4, 5 are formed by bores with circular cross-sections of identical diameter and are swept by the blade 8, as will be explained with reference to FIG. 11.

FIG. 11 shows a portion of the orifice plate 4 with three orifices 5 as well as the blade 8, which is disposed obliquely with respect to the radial direction. The radial extent R of the blade 8 is shown in FIG. 11. As can be seen, the radial extent R is slightly greater than the diameter D of the orifices 5. The consequence of this is that the blades 8 are just sufficient to cut through the plastic melt supplied via the orifices 5, the granules being cut individually and independently from each other because the radial extent R of the blades is only slightly greater than the diameter D, with the consequence that, as the blades 8 rotate, they encounter only a minimal resistance with respect to the flow of the cooling water.

What is claimed is:

1. Device for granulating thermoplastic materials issuing from orifices (5, 6), said orifices (5, 6) being provided in a substantially circular arrangement in an orifice plate (4) and being swept by blades (8, 9) rotating about a blade carrier shaft (11), said blades (8, 9) being held by a bell-shaped blade carrier (10) in an oblique position with respect to the radial direction, the blade carrier shaft (11) extending through the centre of the circular arrangement, a cooling medium being supplied to the orifice plate (4) and to the blades (8, 9) for cooling the granulated plastic materials, wherein between the blade carrier (10) and the orifice plate (4) there is an annular intermediate space (26) which is flowed through from inside to outside by the cooling medium, characterized in that the hollow space (24) of the bell-shaped blade carrier (10) is in communication with the intermediate space (26) and the cooling medium is supplied to the intermediate space (26) from the hollow space of the blade carrier (10).

2. Device according to claim 1, characterized in that the intermediate space (26) is closed off at the sides by an annular plate (7)—attached to the blade carrier (10) and penetrated by the blades (8, 9)—and by the oppositely disposed orifice plate (4), the blades (8, 9) projecting, in the form of individual rigid strips, into the intermediate space (26) from the annular plate (7) up to contact with the orifice plate (4) and being guided and held in the annular plate (7) in penetrations (27) directed obliquely towards the orifice plate (4).

3. Device according to claim 1 or 2, characterized in that the oblique position of the blades (8, 9) projecting into the intermediate space (26) is so chosen that, as the annular plate (7) rotates, said blades (8, 9) oppose a low flow resistance to the resulting flow.

4. Device according to any one of claims 1 to 3, characterized in that the blades (8, 9) are individually adjustable on the annular plate (7), said annular plate (7) being disposed at a fixed distance from the orifice plate (4), wherein, in order to compensate for wear, said blades (8, 9) can during operation be individually pressed against the orifice plate (4) by pressure means (32, 34).

5. Device according to any one of claims 1 to 3, characterized in that the radial extent of the blades (8, 9) exceeds the cross section of the orifices (5, 6) only slightly but to such a degree that the cut executed by the blades (8, 9) chops the plastic material issuing from the orifices (5, 6) into isolated plastic granules.
